(19) United States
(12) Patent Application Publication
(10) Pub. No.: US 2006/0006287 A1
(43) Pub. Date: Jan. 12, 2006

(54) Fairing and airfoil apparatus and method

(76) Inventors: Stanley D. Ferguson, Renton, WA (US); William W. Herling, Bellevue, WA (US); David A. Treiber, Seattle, WA (US)

Correspondence Address: HARNESS, DICKEY & PIERCE, P.L.C., P.O. BOX 828, BLOOMFIELD HILLS, MI, 48303, US

(21) Appl. No.: 11/014,582

(22) Filed: Dec. 16, 2004

Related U.S. Application Data
(60) Provisional application No. 60/537,447, filed on Jan. 16, 2004.

(51) Int. Cl. B64C 1/38

(52) U.S. Cl. 244/130

(57) ABSTRACT

An airfoil for use with high speed mobile platforms. The airfoil features include low peak local mach numbers over the surface avoiding shock, uniform pressure distribution across the entire flight regime, aggressive closure angles for good RF performance, and a scaleable fillet to reduce the stagnation flow region at a leading edge of the airfoil. The airfoil has a scaleable contour for variation in length, height, and length-to-height ratio while maintaining excellent aerodynamic characteristics.

### PRIORITY INFORMATION

The present application claims priority from U.S. provisional application Ser. No. 60/537,447, filed Jan. 16, 2004, entitled “Antenna Fairing and Method”, the entire contents of which are incorporated by reference herein.

### CROSS REFERENCE TO RELATED APPLICATIONS

The present application is related to U.S. application Ser. No. ______, filed concurrently herewith, entitled “Antenna Fairing And Method”.

### FIELD OF THE INVENTION

The present system and method generally relates to airfoils and fairings, and more particularly to a highly aerodynamic airfoil for use on a high speed mobile platform.

### BACKGROUND OF THE INVENTION

Mobile platforms such as aircraft, busses, trains, ships, rotorcraft, etc., typically require an externally mounted antenna to enable communications with a base station transceiver. For example, the CONNEXION BY BOEING^{SM} system enables high speed transmission of digital information from a base transceiver to high speed mobile platforms such as (but not limited to) commercial jet aircraft. With any mobile platform, aerodynamics can be an important consideration. With high speed moving aircraft such as commercial jet aircraft, aerodynamics becomes an especially important consideration in the performance of the aircraft and its operating costs.

With any mobile platform, the mounting of an antenna on an external surface thereof generally operates to negatively affect the aerodynamics of the mobile platform. To protect the antenna and to further mitigate the negative aerodynamic impact of the antenna, a fairing (also referred to as a “radome”) may be used to enclose the antenna over the outer surface portion of the mobile platform. In this instance, the shape of the fairing is important to providing good aerodynamic performance, and therefore ameliorating the negative aerodynamic influence that would otherwise be introduced by the presence of the antenna on the exterior surface of the mobile platform.

Present day fairings, however, are not especially well suited (i.e., shaped) to cover antennas having dimensions required for use with high frequency, satellite based communication systems. Such antennas often project up to 12 inches (30.48 cm) or more above the outer surface of the mobile platform upon which they are mounted, and therefore present a significant “protrusion” or projection that can negatively affect the aerodynamic performance and operational cost of a high speed mobile platform.

When an airfoil is employed on a high speed mobile platform, similar aerodynamic considerations must be considered. For example, the airfoil should have a curvature that avoids shocks at the peak MACH speed that the mobile platform will experience. This requires the local MACH speeds of airflow over various portions of the airfoil to remain at or below about 1.2 MACH. The airfoil should not have significant unstable flow characteristic, i.e., flow separation at the aircraft cruise flight speed, which can shorten the life of the structural hardware due to fatigue damage.

### SUMMARY OF THE INVENTION

The system and method is directed to a uniquely shaped airfoil adapted for use on high speed mobile platforms. The airfoil is highly aerodynamic and presents a low aerodynamic drag when used with high speed mobile platforms such as commercial jet aircraft.

The airfoil incorporates mirror image upper and lower surfaces along its chord-wise center line. In one preferred form the airfoil is formed with a frontal area forming a bull nose shape. In still another preferred form the frontal area includes a pair of mirror image fillets formed one above.

The features, functions, and advantages can be achieved independently in various embodiments of the present system or may be combined in yet other embodiments.

### BRIEF DESCRIPTION OF THE DRAWINGS

The present system will become more fully understood from the detailed description and the accompanving drawings, wherein

FIG. 1 is a simplified view of an aircraft incorporating a fairing of the present system thereon;

FIG. 2 is an enlarged prospective front/side view of the fairing of FIG. 1;

FIG. 3 is a side view of the fairing taken in accordance with directional arrow 3 in FIG. 2;

FIG. 4 is a plan view of the fairing of FIG. 3 taken in accordance with directional arrow 4 in FIG. 3;

FIG. 5 is a front view of the fairing taken in accordance with directional arrow 5 in FIG. 2;

FIG. 6 is a side view graph illustrating the airfoil shape that is used to form the fairing of FIGS. 1-5;

FIG. 7 is a plan view of one-half of the fairing of FIG. 2;

FIG. 8 is a graph illustrating the thickness and length of the fairing in accordance with section line 8-8 in FIG. 5;

FIG. 9 is a front view graph illustrating a profile of one half of the fairing;

FIG. 10 is a graph illustrating the peak Mach values at various points along the fairing of FIGS. 2-5 at various Mach levels;

FIG. 11 is a flow field plot illustrating Mach values for airflow over the fairing at 0.41 Mach;

FIG. 12 is a plot illustrating a 0.78 Mach flow field for airflow over the fairing;

FIG. 13 is a plot illustrating a 0.85 Mach flow field for air flowing over the fairing;

FIG. 14 is a pressure contour graph illustrating the similarity of the pressure contour at the centerline to the buttock line edge of the fairing;

FIG. 15 is a computer generated model of a portion of the fairing illustrating airflow velocity in a recirculation zone at a leading edge of the fairing;

FIG. 16 illustrates a computer generated model of the trailing edge area of the rear portion of the fairing, and the velocity contours at this region;

FIG. 17 illustrates a complete airfoil formed in accordance with the curvature of the airfoil of FIG. 6;

FIG. 18 is a graph of the drag rise for the airfoil of FIG. 17 at various aircraft local Mach numbers; and

FIG. 19 is a graph of the uniform pressure load over the airfoil.

### DETAILED DESCRIPTION OF THE PREFERRED EMBODIMENTS

The following description of the preferred embodiment(s) is merely exemplary in nature and is in no way intended to limit the system, its application, or uses.

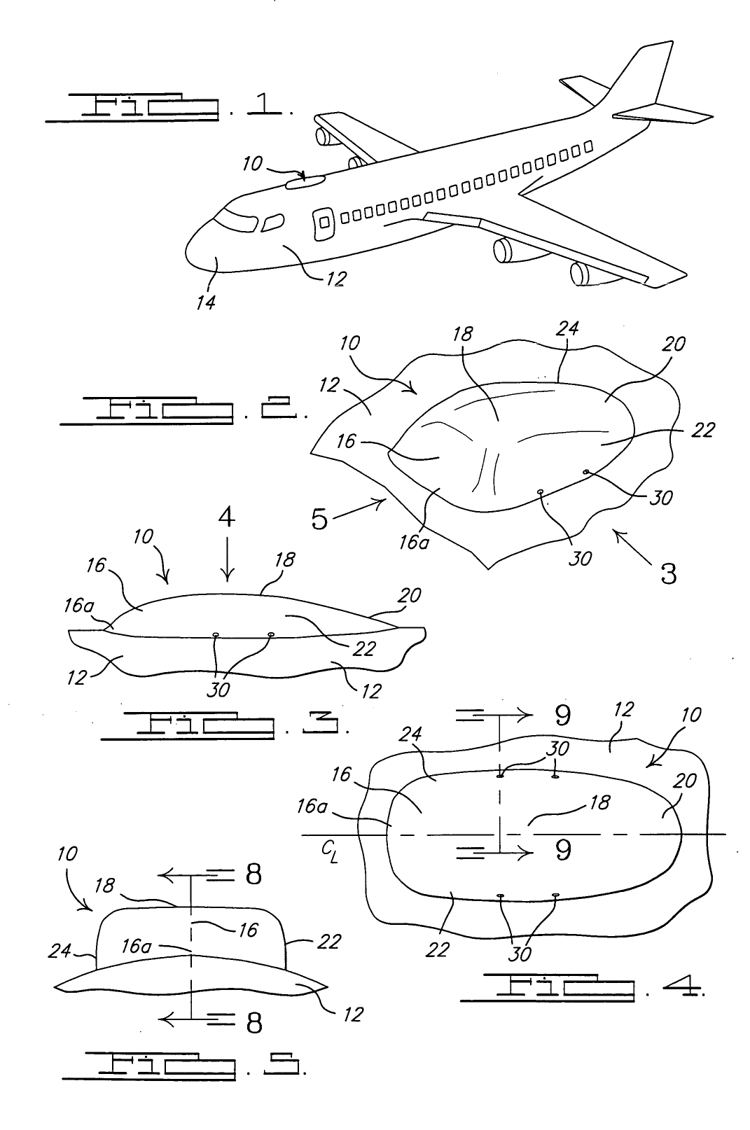

Referring to FIG. 1, there is shown a fairing 10 in accordance with a preferred implementation. The fairing 10 is illustrated as being disposed on an outer surface of a fuselage 12 of a mobile platform 14, which in this example is illustrated as a jet aircraft. It will be appreciated that the fairing 10 can be readily used with virtually any mobile platform where it is important to enclose some component mounted on an exterior surface of the mobile platform so that the negative aerodynamic affects of the component can be minimized. As can be appreciated, with high speed mobile platforms such as aircraft, rotorcraft, space vehicles and high speed land vehicles, the aerodynamic performance of the mobile platform can be an important consideration. The fairing 10 serves to ameliorate the negative affects that would otherwise be introduced by an external component mounted on a mobile platform, and also to prevent separation of the airflow flowing over the fairing 10 that could produce shocks perceptible to occupants within the mobile platform.

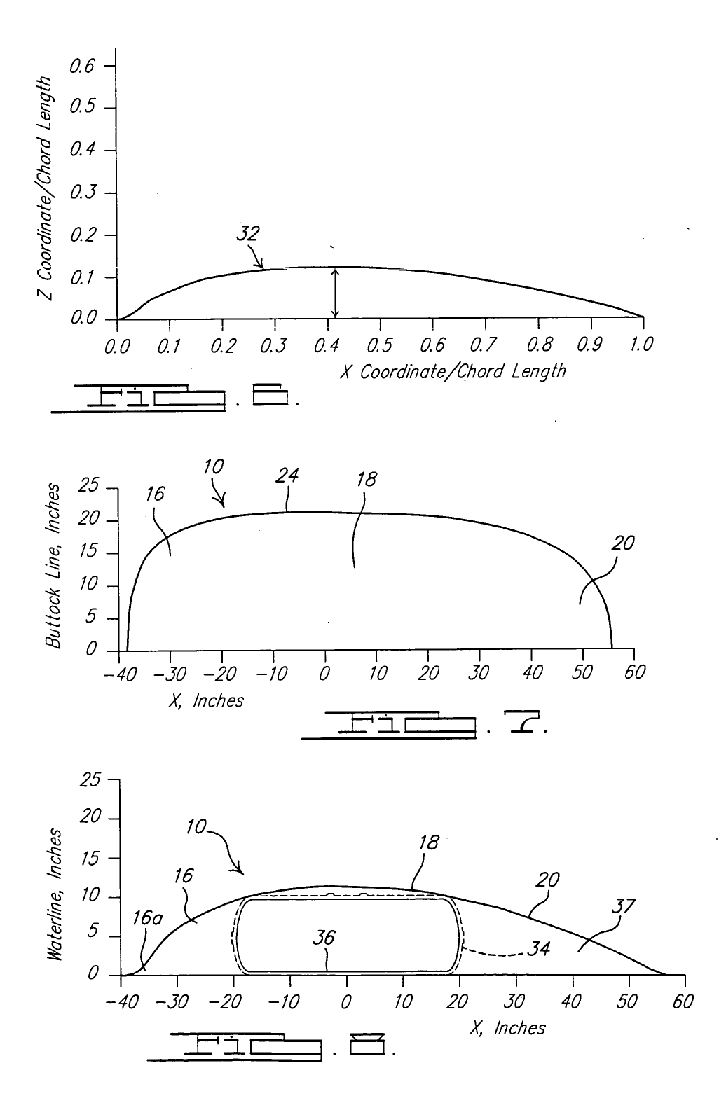

With reference to FIGS. 2-5, the fairing can be seen in greater detail. The fairing 10 includes a frontal portion 16, a top or upper portion 18, a tapering rear portion 20, and gradually curving side portions 22 and 24 on opposite sides of the top portion 18. In FIG. 3, the frontal portion 16 can be seen to include a small fillet 26. Fillet 26 helps to reduce or eliminate the stagnation region at a leading edge 16a of the frontal portion 16. As will be appreciated, the presence of a stagnation region is undesirable. Fillet 26 helps to reduce or eliminate the presence of such a region and to insure that airflow moves smoothly over the fairing 10 as the mobile platform 14 is traveling.

With further reference to FIGS. 2-5, the fairing 10 further preferably includes a pair of vents 30 on each of the side portions 22 and 24. Vents 30 are further preferably formed close to the area of intersection of side portions 22 and 24 and the outer surface 28 of the mobile platform 14. While four vents 30 are shown, it will be appreciated at greater or lesser number of such vents could be incorporated. The vents 30 serve to equalize the pressure on interior and exterior surfaces the fairing. The vents 30 are shown as circular shaped vents, however other shapes such as, for example, rectangular or square shaped vents, could also be employed. In one form the vents 30 define circular openings of about 0.375 inch (9.525 mm) each in diameter.

It will be appreciated that in some applications the vents 30 may not be needed. However, if the fairing 10 is incorporated on an airborne mobile platform such as a jet aircraft, then it is preferred to include the vents because pressure equalization on the fairing 10 will be desired during climb and descent phases of flight of the aircraft.

The fairing 10 can be used to enclose any component that is not itself aerodynamically shaped, that would otherwise introduce more than insignificant drag on a mobile platform during its operation. The fairing 10, in one implementation, is used to enclose an antenna and to provide sufficient clearance to allow the antenna to be rotated without interference from any portion of the fairing 10. The fairing 10 is preferably manufactured from a lightweight structural material compatible with its intended use, e.g., transparent to radio frequency transmission such as glass or quartz, either in solid laminate or composite form. Other suitable materials could also be employed.

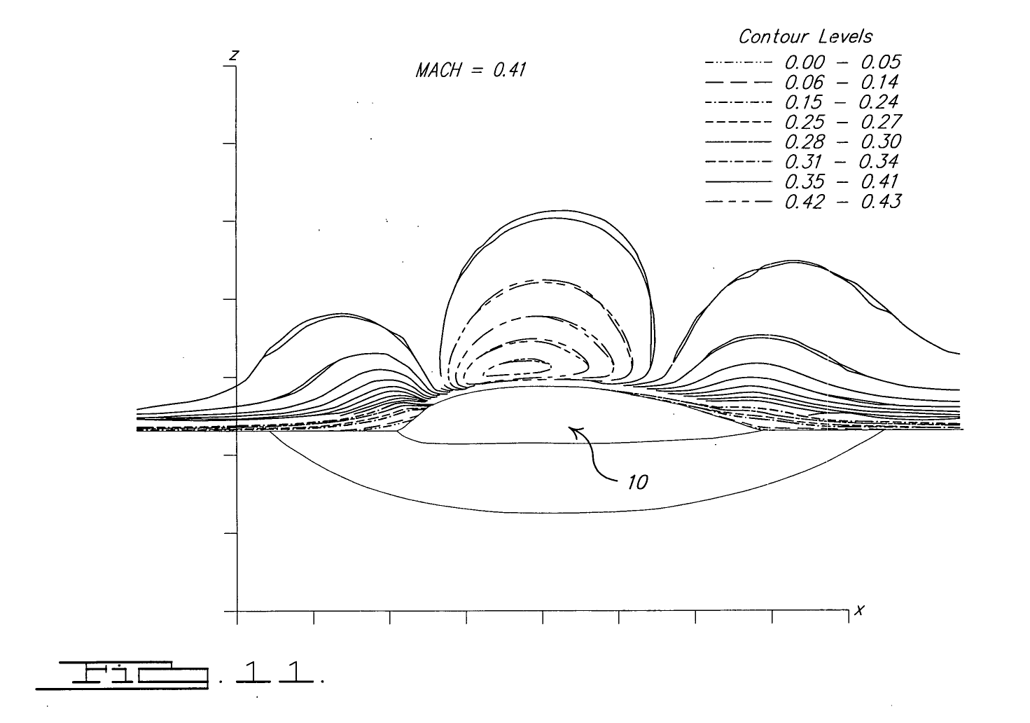

Referring to FIG. 6, a graph is presented illustrating the thickness-to-length ratio of an airfoil shape 32 that is used to form the fairing 10. Essentially, airfoil shape 32 is scaled as needed in its x, y and z directions to provide an enclosure sufficient to house the component over which the fairing 10 is secured. In one preferred form the airfoil shape 32 has a thickness ratio of preferably about 12%.

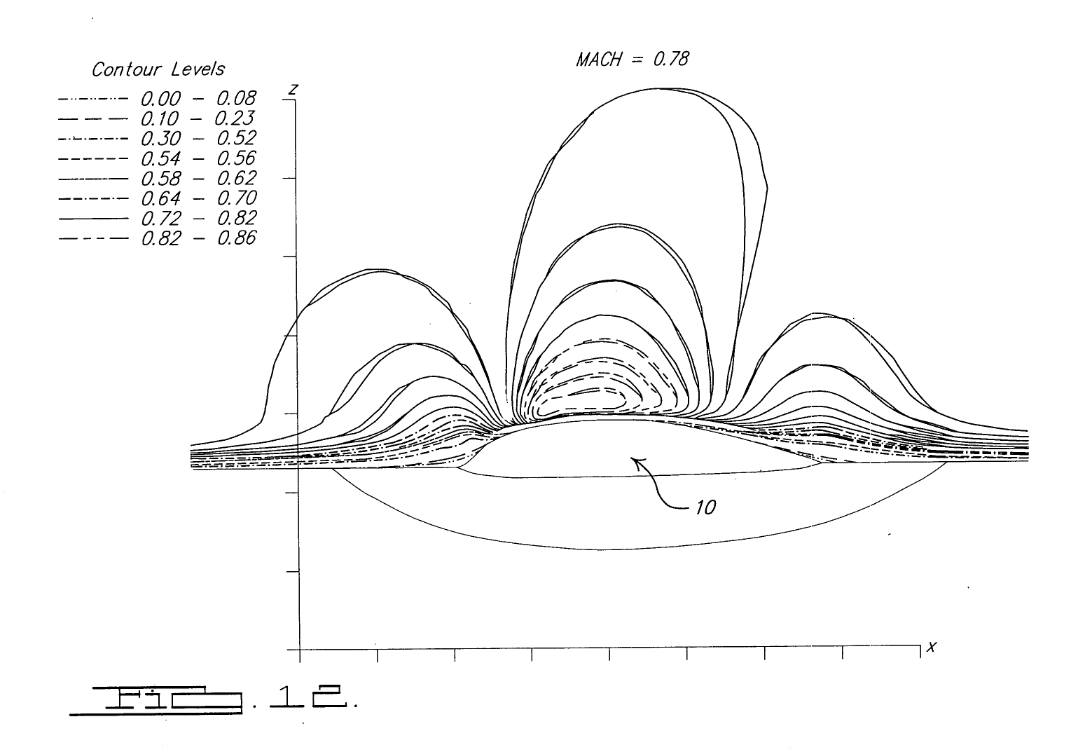

Referring to FIG. 7, a graph illustrating one half of the fairing 10 in plan form can be seen. In this example, the overall chord-wise length (X) of the fairing 10 is preferably between about 90-100 inches (228-254 cm), and more preferably about 94 inches (238.76 centimeters). The maximum buttock length from the longitudinal centerline of the fairing 10 is about 21 inches (53.34 centimeters). The maximum overall buttock length, in this example, is about 42 inches (106.68 cm).

Referring to FIG. 8, a graph illustrating the fairing 10 in relation to an envelope 34 can be seen, where the envelope 34 defines that space required for enabling movement of a rotatable antenna 36 within an interior area 37 of the fairing 10. In this preferred implementation, the fairing 10 has an overall height maximum height of about 12 inches (30.48 cm). It will be appreciated that the fairing 10 can be scaled in accordance with the basic airfoil shape 32 shown in FIG. 6 to accommodate larger or smaller components.

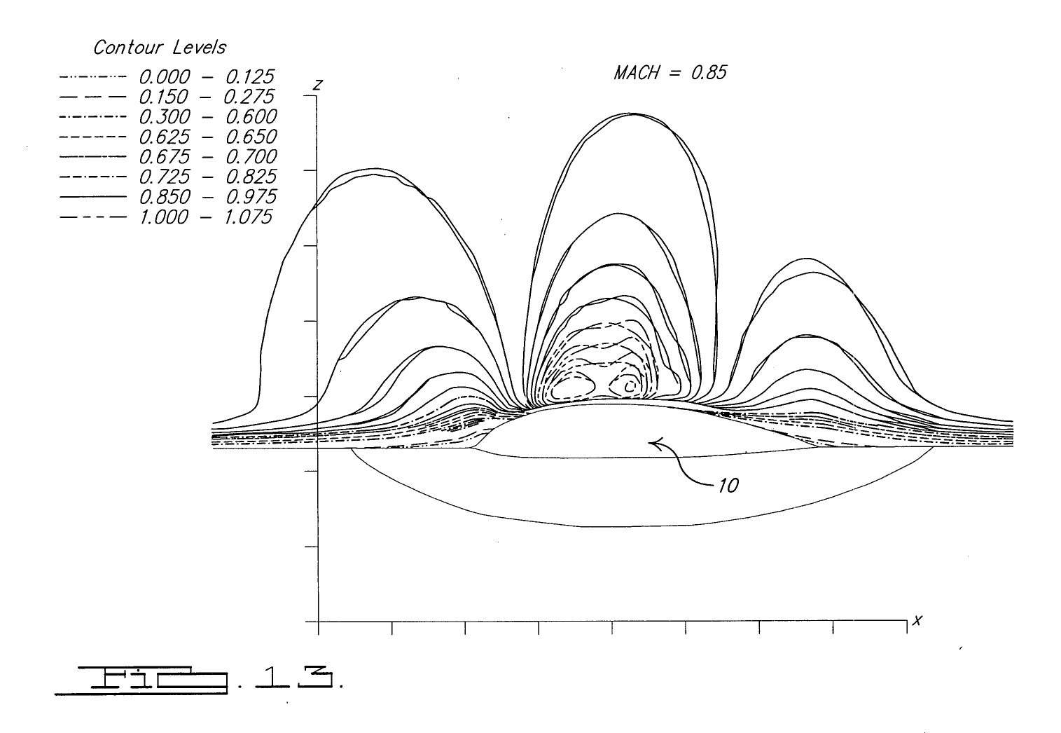

FIG. 9 illustrates the contour of one of the side portions 22 of the fairing 10.

FIG. 10 illustrates the peak Mach number profiles for airflow over the fairing 10 when the fairing is moving at a velocity of 0.41 Mach, 0.78 Mach and 0.85 Mach. Curve 40 defines the Mach number profile at 0.41 Mach, curve 42 defines the Mach number profile at 0.78 Mach and curve 44 defines the Mach number profile of air flowing over the fairing 10 with the fairing moving at a velocity of 0.85 Mach. From these three graphs it should be appreciated that the fairing 10 produces low peak Mach number profiles. Put differently, graphs 40-44 indicate that the Mach number of the airflow at the local centerline of the fairina 10 remains very close to the speed of the mobile platform. With the low peak Mach number across the airfoil 10, shocks and flow separation are delayed to speeds above the cruise speed of all modern commercial aircraft. This allows a broad range of applications for the fairing 10 design.

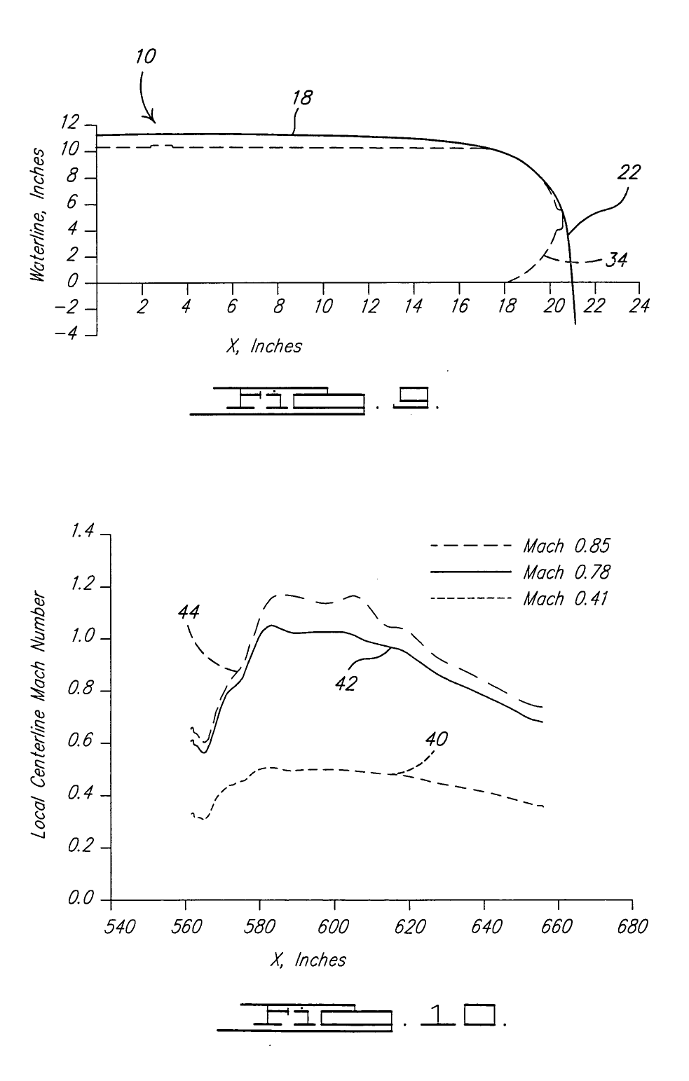

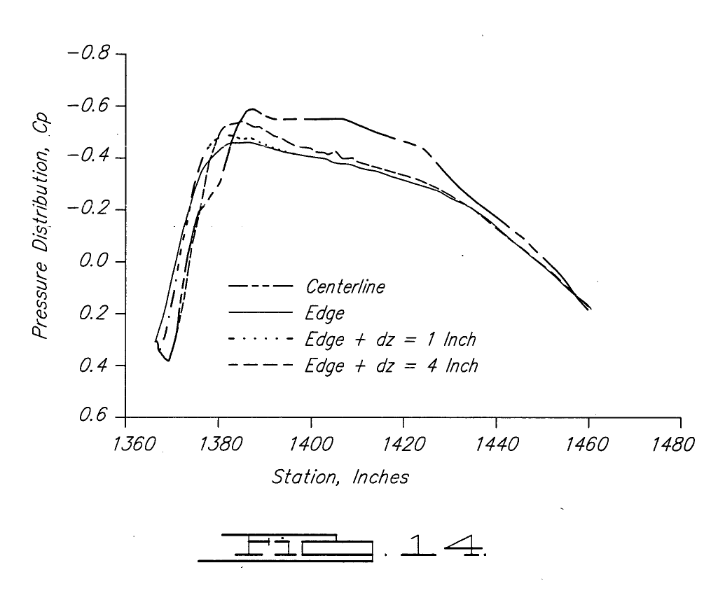

FIGS. 11-13 illustrate the peak Mach values of the airflow over the fairing 10 at speeds of 0.41 Mach, 0.78 Mach and 0.85 Mach, respectively. In particular, FIGS. 11-13 illustrate the local Mach number on the centerline plane of the fairing 10 (as designated by “C_{L}” in FIG. 4). It will be appreciated that the Mach number is the local velocity divided by the speed of sound. The Mach number distribution is nearly flat and uniform across the top portion 18 of the fairing 10 and remains so as the speed increases. This characteristic means that the pressure waves develop uniformly, which avoids the development of shocks and flow separation at high speed. This flow characteristic also keeps the drag low, as can be shown by an optimization computer. The Figures show that low speed flow in the leading edge 16 region and trailing edge region 20 are limited to small areas (subject to separated flow). By minimizing the shocks and flow separation, the aerodynamic noise (that can result in aircraft cabin noise), sonic fatigue loads and vibration level (that impacts fatigue life of the installation) are kept low. However, sufficient curvature is maintained in the profile of the fairing 10 to avoid structural buckling when lightweight material is used. Lightweight material is preferred, and particularly lightweight composite materials, that enable excellent radio frequency performance.

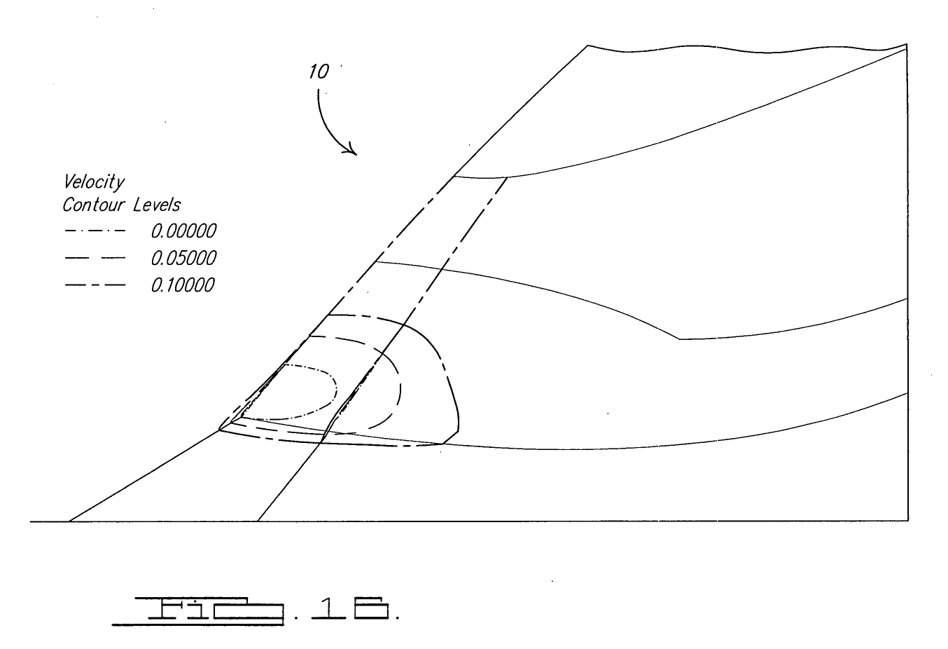

FIG. 14 illustrates a graph of the pressure distribution from the local centerline of the fairing 10 to an edge of the side portion (either 22 or 24), at various points between the local centerline and the outermost edge of the side portion 22 or 24 where the portion insects the fuselage 12 of the mobile platform 14. The uniform pressure distribution is maintained from the centerline to the outboard edge by defining the planform in a manner to allow a common airfoil section. This planform definition provides the desired clearance for the needed antenna swept volume for a rotating antenna. A common airfoil and planform that allows a uniform transition from the centerline to the outboard edge (i.e., the edges adjacent side portions 22 and 24) allows the fairing 10 to maintain good performance across a wide range of flight conditions. Since the pressure profile at the outboard vent location (for vents 30) is similar to the pressure profile on the centerline, properly located vents will equalize the pressure loads across the entire fairing 10. This keeps the normal flight loads low and allows the use of a wide range of material for the fairing 10 design and increases the design life of the installation and internal hardware.

FIG. 15 illustrates in greater detail a portion of the fairing 10 at a leading edge of the front portion 16, and velocity contours for flow in this region. It will be appreciated that when the velocity contour is negative, the flow is upstream. When the velocity is zero, it is the contour line where the flow separates from the surface of the fairing 10.

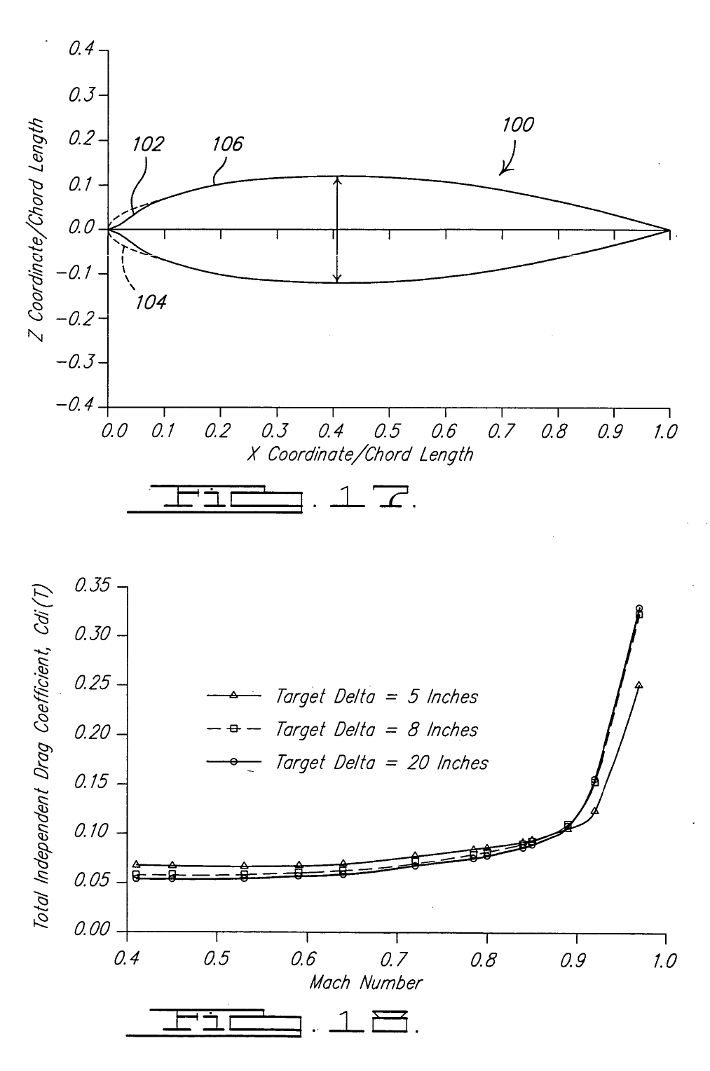

FIG. 16 illustrates a similar flow characteristic that occurs at a trailing edge region of the rear portion 20 of the fairing 10, but for a different reason. FIG. 16 illustrates normal flow separation where the surface slope becomes too large for the flow to stay attached to the fairing 10. Again, velocity zero represents the boundary and a negative velocity represents upstream flow. A design objective is to maintain these regions (shown in FIGS. 15 and 16) small by the design of the fairing 10 and airfoil 32 shape.

FIG. 17 illustrates a complete airfoil 100 in profile along a longitudinal centerline thereof. The airfoil 100 is essentially identical to the airfoil 32 of FIG. 6 but with a mirror image lower half portion included. Although shown in solid lines with a fillet 102, dashed lines 104 at a leading edge area 106 indicate that a bull nose leading edge portion could just as readily be incorporated. The fillet 102 has been found to reduce the stagnation recirculization region. Optionally, adding a fillet ahead of the bullnose (indicated by dashed lines 104) can eliminate the stagnation region altogether, although at the expense of increasing the overall length of the airfoil 100 slightly (i.e., by about 10%).

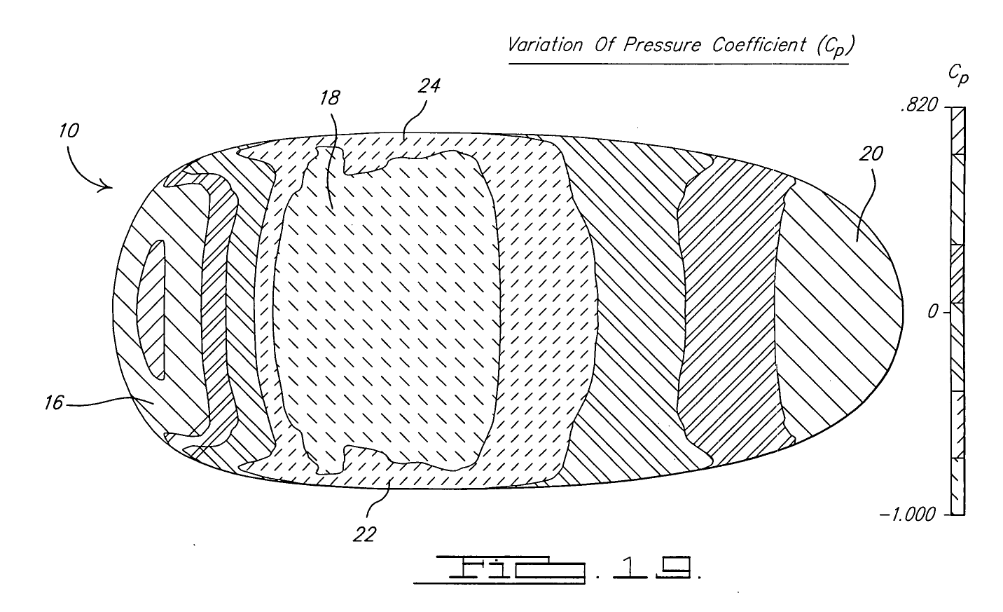

It was also desired to provide sufficient curvature over the center portion of the fairing 10 and the airfoil 100 to avoid any structural problems. High normal loads (normal to the fairing 10 surface) can be induced on the fairing 10 by the aircraft local flow field or failure events, e.g., decompression of the cabin air into the fairing or emergency descent under icing conditions. Curved surfaces provide additional strength to the structure allowing the use of lightweight material required for good RF performance. However, increased curvature results in higher peak Mach numbers. It is highly desirable to keep the peak Mach low enough to avoid a shock at the maximum cruise Mach speed. The shock causes flow separation, increases drag and vibration. FIG. 18 illustrates that the airfoil 100 and fairing 10 perform to maintain the drag rise (a result of shocks) above 0.9 for the aircraft local Mach number. Aircraft are required to have no perceptible buffet or vibration up to the maximum operating mach number for the aircraft. By designing the fairing 10 to avoid shocks and any significant flow separation for local mach numbers up to 0.9 (well above maximum cruise mach (0.85) for modern aircraft) the probability of perceptible buffet or vibration is eliminated. In addition for normal cruise, the absence of any significant vibration for the majority of the flight time will avoid structural fatigue damage and increase the fairing 10 and attachment hardware life limits and structural inspection intervals. This design approach also enhances the probability that the fairing 10 will perform as well as other aircraft component, i.e, wing and tail surfaces, at the aircraft maximum design (demonstrated flight) flight speed, which can be up to mach 0.97.

FIG. 19 illustrates the uniform pressure flow distribution over the fairing 10 from a longitudinal centerline of the fairing 10 to its outboard side portions 22 and 24. The term “Cp” indicates pressure coefficient. The Cp range is from −1 to +0.8 where Cp=(delta static pressure)/(dynamic pressure). “Dynamic pressure” can be defined as follows:
Dynamic pressure=0.5×density×velocity²
where the density is the air density at the flight altitude and velocity is the velocity of the aircraft.

“Delta static pressure” is the net of the external pressure minus the internal pressure on the fairing 10. FIG. 19 highlights the uniform pressure distribution from the longitudinal centerline of the fairing 10 to the outboard edges. Using a single airfoil for the fairing 10 provides a uniform variation in pressure as you go outboard toward the side portions 22,24, and a similar profile for the pressure distribution. Thus, the pressure at the longitudinal centerline and the outboard edges (i.e., side portions 22,24) are similar. In addition, the pressure at the vent locations 30 (FIG. 4) is close to the pressures across the fairing (inboard to outboard) and the resulting internal pressure (equal to the vent pressure) will minimize the fairing loads for normal flight (i.e., the internal pressure load more closely balances the external pressure load).

The fairing 10 thus avoids low grazing angles for an antenna beam and a trailing edge surface of the fairing. The fairing 10, however, still provides sufficient clearance to mount an antenna thereunder. Sufficient curvature is also provided on a top portion of the fairing 10 to avoid structural buckling under high loads, but not so much curvature that would result in a high crown Mach number. The fairing 10 further is usable at high aircraft cruise Mach numbers (i.e., 0.85 Mach), aircraft maximum operating Mach numbers up to, or possibly exceeding, 0.92 Mach, and aircraft maximum design (demonstrated flight) mach numbers up to, or possibly exceeding, 0.97. The fairing 10 minimizes flow separation, minimizes incremental drag, and is scaleable in its thickness ratio to maintain uniform inboard to outboard pressure distribution.

The fairing 10 provides a means for enclosing a relatively large component on an exterior surface of a mobile platform, and most advantageously on a mobile platform adapted to travel at high speeds, in a manner that significantly reduces or essentially eliminates the negative aerodynamic consequences that would otherwise be created by the component. Importantly, fairing 10 utilizes an airfoil shape that maintains the peak local Mach number at various portions over the fairing 10 low to avoid shocks that could otherwise be created by local Mach numbers greater than about 1.2 in magnitude. The fairing 10 further provides very low aerodynamic drag. The fairing 10 further does not negatively impact the performance of the aircraft (or other form of mobile platform) on which it is installed, or otherwise complicate construction of the mobile platform itself. The fairing 10 is lightweight and readily adaptable and scalable to a wide range of mobile platforms to cover a wide range of components protruding from an exterior surface of the mobile platform.

Still another advantage of the fairing 10 is the overall contours of the fairing produce very good radio frequency (RF) incidence angles. By this it is meant that when the fairing 10 is used to enclose an antenna that is transmitting information or data, the contours of the fairing 10 significantly reduce the distortion or refraction of the electromagnetic beam. by the surface of the fairing 10. These effects on the electromagnetic beam cause beam scattering and reduce the operating efficiency of the antenna or can result in failure to meet regulatory requirements.

While various preferred embodiments have been described, those skilled in the art will recognize modifications or variations which might be made without departing from the inventive concept. The examples illustrate the invention and are not intended to limit it. Therefore, the description and claims should be interpreted liberally with only such limitation as is necessary in view of the pertinent prior art.

What is claimed is:

1. An airfoil for use on a mobile platform, comprising:
a chord length designated by X;
a chord thickness at a local center line representing a thickness designated by Z; and
wherein one-half of a thickness (Z) of said chord forms a ratio (Z/X) approximately within a range of about 11-13%.

2. The airfoil of claim 1, wherein said ratio comprises a ratio of about 12%.

3. The airfoil of claim 1, wherein said airfoil comprises a frontal portion, and wherein said frontal portion comprises a frontal area of at least approximately three square feet for the fairing.

4. The airfoil of claim 3, wherein said airfoil produces a peak local Mach number for air flow along said local center line, when said mobile platform is moving at about Mach 0.41, in accordance with a graph of FIG. 11 herein.

5. The airfoil of claim 1, wherein said airfoil produces a peak local Mach number for air flow along said local center line, when said mobile platform is moving at about Mach 0.78, in accordance with a graph of FIG. 12 herein.

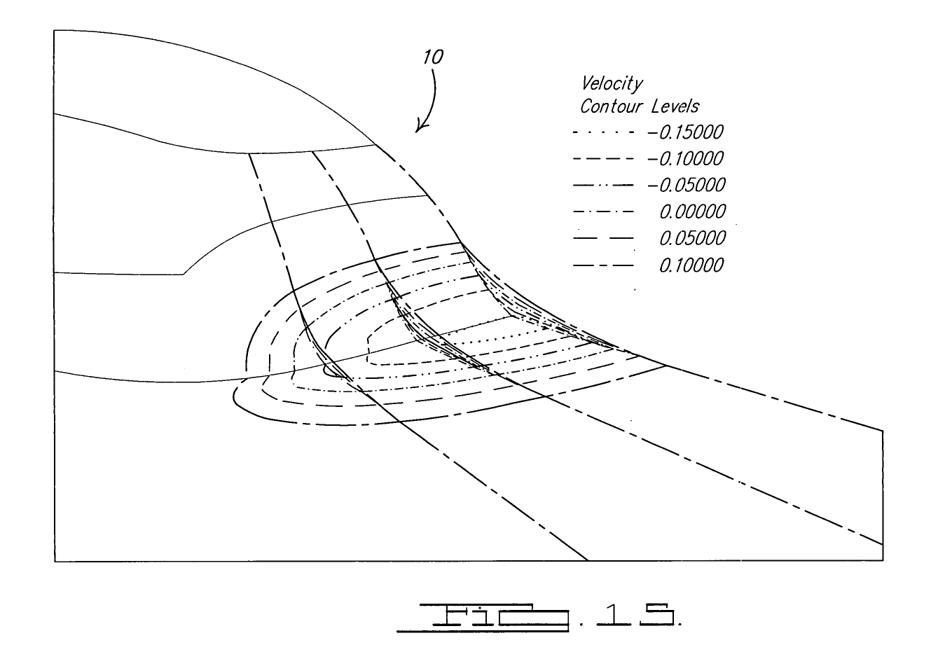

6. The airfoil of claim 1, wherein said airfoil produces a peak local Mach number for air flow along said local center line, when said mobile platform is moving at about Mach 0.85, in accordance with a graph of FIG. 13 herein.

7. The airfoil of claim 1, wherein the airfoil (incorporated into the fairing) produces an aerodynamic drag of no more than about 50 pounds when said mobile platform is traveling at an airspeed of about 0.80-0.90 mach.

8. The airfoil of claim 7, wherein the airfoil (incorporated into the fairing) generates no more than about 50 pounds of dran at about 0.85 mach.

9. The airfoil of claim 1, wherein said chord length comprises a length of between about 90-100 inches (228.6-254 cm).

10. The airfoil of claim 1, wherein said chord thickness (Z) comprises a maximum half thickness at said local centerline of about 12 inches (30.48 cm).

11. The airfoil of claim 1, wherein said airfoil further comprises a frontal portion, said frontal portion including a fillet.

12. The airfoil of claim 1, wherein said airfoil comprises a bull nose shape at a frontal portion thereof.

13. An airfoil for use on a mobile platform, comprising:
a chord length designated by X;
a chord thickness at a local center line representing a thickness designated by Z; and
wherein one-half of a thickness (Z) of said chord forms a ratio (Z/X) approximately within a range of about 11-13%; and
wherein said airfoil includes a frontal portion, said frontal portion including a fillet.

14. The airfoil of claim 13, wherein said frontal portion includes a pair of fillets on opposite sides of a longitudinal centerline extending through a midpoint of said chord thickness.

15. The airfoil of claim 13, wherein said airfoil generates peak local Mach numbers of no more than about 1.2 over its surface.

16. The airfoil of claim 13, wherein said airfoil generates peak local Mach numbers along a longitudinal centerline extending lengthwise in said X direction in accordance with a graph of FIG. 10 herein.

18. A method for forming an airfoil comprising:
forming said airfoil with a chord length designated by X;
forming said airfoil with a chord thickness at a local center line representing a thickness designated by Z; and
wherein one-half of a thickness (Z) of said chord forms a ratio (Z/X) approximately within a range of about 11-13%; and
forming said airfoil to include a frontal portion, said frontal portion including a fillet.

19. The method of claim 18, further forming the airfoil with said chord length (X) comprising a length of between about 90-100 inches (228.6-254 cm).

20. The method of claim 18, further forming the airfoil with said chord half thickness (Z) comprising a thickness of about 12 inches (60.96 cm).

21. The method of claim of claim 18, wherein said airfoil generates peak local Mach numbers in accordance with the graph of FIG. 10 herein.

22. A method for forming an airfoil comprising:
forming said airfoil with a chord length designated by X;
forming said airfoil with a chord thickness designated by Z at a local center line; and
wherein said airfoil has a ratio (Z/X) approximately within a range of about 22-24; and
forming said airfoil to include a frontal portion having a bull nose shape.

23. The method of claim 22, further comprising forming said chord length to comprise a length of about 90-100 inches (228.6-254 cm).
